(19) United States
(12) Patent Application Publication
(10) Pub. No.: US 2012/0278248 A1
(43) Pub. Date: Nov. 1, 2012

(54) Interactive Method for Facilitating Employment Searches

(76) Inventor: Timothy Harvey, Rio Rancho, NM (US)

(21) Appl. No.: 13/453,537

(22) Filed: Apr. 23, 2012

Related U.S. Application Data
(60) Provisional application No. 61/479,020, filed on Apr. 26, 2011.

(51) Int. Cl. G06Q 10/06

(52) U.S. Cl. 705/321

(57) ABSTRACT

A method and system for job recruiting employing a physically distributed employer video presentation on detachable memory devices that may be selectively accessed by a job applicant through a communication terminal and the internet.

### CROSS-REFERENCE TO RELATED APPLICATIONS

This non-provisional utility patent application claims priority from an earlier filed U.S. provisional patent application, Ser. No. 61/479,020 entitled “System, Software and Method for Facilitating Employment Searches,” filed by or on behalf of Timothy Wayne Harvey, on Apr. 26, 2011, the subject matter of which is hereby incorporated in its entirety by reference herein.

### FIELD OF INVENTION

This invention generally relates to job recruiting and more specifically to a method for an on-line system integrated with detachable memory devices.

### BACKGROUND OF THE INVENTION

Since time immemorial there has always been a high level of activity in the field of linking job seekers or candidates with employers in an efficient manner. Candidates spend time looking for employment opportunities while employers are conversely seeking employees to fill vacant job positions.

For many years, the search for jobs was conducted through advertisements in print media generally referred to as “classified ads.” This conventional or traditional method had many deficiencies such as the lack of timely information about employment opportunities, the limited geographic coverage because the print media was typically regional, or the coverage was by advertisements in trade magazines which are not readily accessible to certain job seekers. Employers also found that for professional or semi-professional positions general media, such as newspapers, failed to identify appropriate target job candidates for the particular specialized positions.

These difficulties were largely overcome after the advent of the Internet and its popularity for both posting job opportunities by employers and resumes or availability information by persons seeking employment. However, while the efficiency of job matching may be improved by virtue of on-line activity, the enormous volume of information available has made it more difficult for job candidates to locate a suitable prospective employer with a matching job opening or the posting of job opportunities on employer websites which of course requires pre-existing knowledge of the job candidate to access. While recruiters, as in the past, also facilitate the matching of candidates with open positions, the cost to prospective employee or employer may be prohibitive.

One shortcoming from the employer's perspective is the inability to provide sufficient information to an interested job applicant in an efficient, low-cost, yet highly proprietary or exclusive manner. Specifically, although classic advertising techniques may be employed to provide both text and graphics that will initiate interest in a potential job seeker, the more detailed information, that adequately demonstrates the potential opportunity using text and graphics is not always effective. On the other hand, providing detailed information, for example in a video presentation, on a website, offers no assurance that a potential job seeker will either intentionally or randomly access the website to obtain the type of information that a serious job seeker will want in order to continue investigation of a job opportunity. Many job seekers have limited time to surf the Internet nor desire to acquire the expertise to efficiently conduct a search that provides more information than the typical “job boards.” Moreover, since the employer's presentation on the generally available Internet website would be accessible to potential competitors, it may not be desirable to post the detailed information on a generally available website.

In addition to media or web advertising by employers for the interest of employees, there are other methods for linking job candidates and employers, such as job fairs. Since employers often seek recently educated and trained individuals, employers may also attempt to use the job placement capabilities of a college and university, as well as specialized educational institutions, where there is a constant supply of new entrants into the job market. Yet except for the most well-disciplined young job seekers, it is often difficult for them to find the time to fully investigate the opportunities that may be available. Accordingly, they often are aware of local opportunities and may confine themselves to a close geographic area simply for lack of information about opportunities on a broader geographic scale and the availability of time to fully research and investigate those remote opportunities.

Accordingly, it is believed that there is a potential opportunity for an employer to provide sufficient information to potential job seekers that would fully disclose their opportunities, their character, their culture, and other characteristics that a job seeker will be interested in. Based on the foregoing disadvantages or deficiencies, it is the general purpose of the present invention to provide an improved combination or integration of web or internet-based information together with employer-personalized detailed information that may be economically provided to job seekers without disclosing that information through generally available public systems, like the Internet itself.

### SUMMARY OF THE INVENTION

In one embodiment of this invention there is provided a method for facilitating the employment process by identifying a potential employer and preparing descriptive material relating to it including a video presentation of the employer's activity; preparing a plurality of detachable memory devices, each device including an interface to a computer terminal, the descriptive material of the employer, a blank application for employment, and an operational communication procedure stored on the device that prohibits access to the employer descriptive material without completing and transmitting the employment application; identifying an administrative entity associated with a cohort of job candidates; sending a plurality of the detachable memory devices to the administrative entity for distribution to the cohort; permitting job candidates to access the communication procedure on the devices to transmit the application form for employment; receiving the completed form at a central server; storing the completed application for employment on the central server; and maintaining a database of the stored employment applications.

In another embodiment of the invention, a system is operated by a recruiter of job candidates to assist an employer in locating and attracting such candidates by preparing in cooperation with the employer a video presentation of the employer's operations and activity on detachable memory devices, the devices provided with software that allows a user, such as a job candidate, to complete a job application form, employing third parties to distribute the detachable memory devices with the employer presentation, allowing job candidates who receive the detachable devices to connect the devices to a communication terminal connected to a network, equipping the devices with a software program that prohibits access to the employer presentation until the candidate completes the job application form, receiving and storing job applications forms, in a server connected to the network and permitting the employer access to the candidates that have received the detachable devices and have completed the job application form.

### BRIEF DESCRIPTION OF THE DRAWINGS

For a better understanding of the invention, reference should be made to the detailed description in conjunction with the accompanying drawings in which:

FIG. 1 is an embodiment of a system in accordance with the invention;

FIG. 2 is a flowchart of one portion of one method embodiment of the system shown in FIG. 1;

FIG. 3 is a flowchart of a second portion of the method embodiment shown in FIG. 2;

FIG. 4 is a flowchart of a third portion of the method embodiment of shown in FIG. 2;

FIGS. 5 and 5A show an exemplary video presentation comprising one feature of the system and method of the embodiment of the invention.

### DETAILED DESCRIPTION OF EMBODIMENT OF THE INVENTION

The various embodiments described herein are subject to numerous variations and therefore substitutions, equivalents, omissions and other changes are contemplated without departing from the scope or spirit of the invention.

The term “communication terminal” is used to describe a wide variety of computer processor based devices that are equipped with the capability to communicate with other devices over a network, such as the internet but including private or semi-private networks requiring access, such devices include a desktop computer, a portable or laptop computer, a smart phone, a so-called I-pad, or any similar device that permits the terminal to send and receive messages to and from other devices over the network.

The term “job candidate” means a person seeking employment.

### System Description

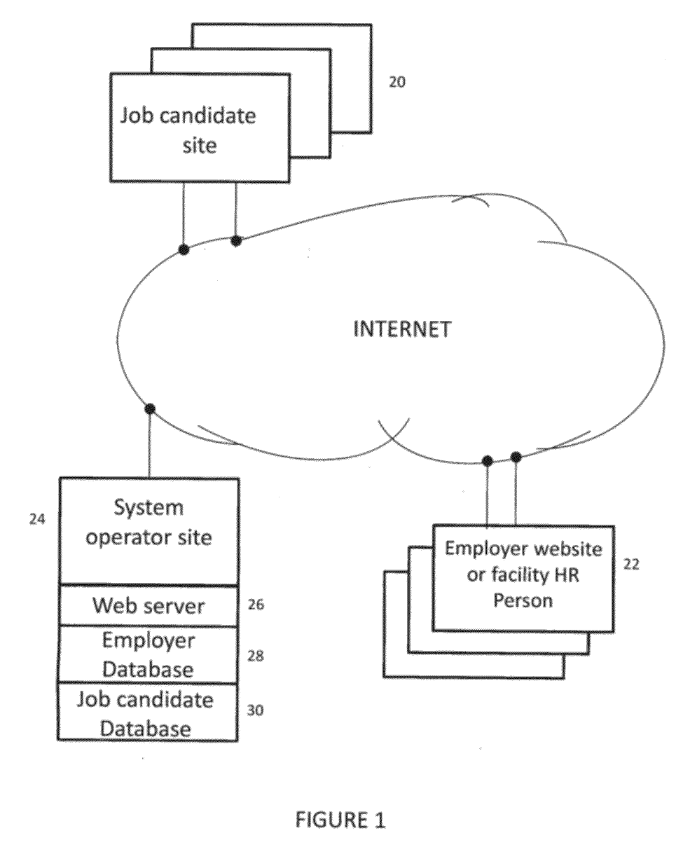

FIG. 1 shows the system embodiment for the invention that operates over the internet, although it will be understood that the interne is an exemplary network and the system could be connected to any multi-user communication path whether public or private, regional, national or international in geographic scope. As shown, there may be multiple communication terminals or clients 20 connected to the interne and operated by job candidates. These terminals include provision for connection to external memory devices that are detachable from the terminal. The detachable memory devices include, within a housing, a mechanical connector, one or more memory chips, a clock, and a computer or microcontroller with a limited amount of RAM and ROM that provides the communication interface enabling the transfer or transmission of data from and to the terminal and device. A currently popular detachable memory device is the Universal Serial Bus (USB) that includes the components as described. Most current communication terminals include one or more USB ports and therefore readily receive and communicate with an external memory device. These USB devices are colloquially referred to as a “stick,” “thumb drive,” “skateboard” and the like. They may be procured with various amounts of memory currently in the range of one GB to one TB. The devices are small and lightweight and are easily carried in a person's pocket. In volume, they are inexpensive, particularly in the smaller memory capacities.

It will be understood that the terminals and the job seekers may be located anywhere that an internet connection is available. It is anticipated that many potential users of the system will be students that are completing an educational program from a university, college, junior college, secondary school, trade school or similar institution. The institutions of higher learning typically have outplacement offices as an administrative entity, that in the present invention, functions as a third party intermediary between the job candidate and employer that attempts to facilitate the hiring process through various means including interview opportunities, job fairs, and similar activities. Beyond student candidates there are a substantial number of persons who are either employed or in-between employment and are seeking a new job or career opportunity. These job candidates attend job fairs sponsored by employers, industries, or government entities where the memory devices may be distributed. In some professional fields having scientific conferences or trade shows on a periodic basis there are opportunities for job candidates to access information regarding available positions.

The system of the embodiment shown also includes employer sites 22 that are connected to the internet. These entities range widely in size but have a common desire to attract qualified candidates who may be further vetted for open positions. These participants in the system are generally more sophisticated in the process of filling positions in the entity and much more sensitive to the costs in locating, interviewing, and attracting job candidates to open positions. They typically are aware of the costs in general media advertising, website advertising, campus interviews, and the ubiquitous recruiters that seek to consummate employment relationships. In certain fields, such as medicine or science, where the employees typically have specialized skill sets, employer searches for candidates may be intense and expensive.

A particular problem with medium or large employers is finding the opportunities to present detailed information about their company, the culture, the locations, the specific positions open, their operations, business units, and diverse aspects that they believe distinguish them from their competitors. While a website offers that opportunity it also offers many distractions for the job seeker, both in terms of other opportunities or the wide variety of personal information that the seeker may be interested in.

The third type of participant in the system is the system operator itself who maintains a site on the internet at 24. At this site there is a server 26 providing an interne connection as well as a computer processor with permanent memory and a software database. In addition the system operator organizes the entire operation of controlling the interaction of the prospective employers and job candidates. In particular the system operator provides the unique opportunity to employers that is offered by the present invention embodiment.

The server 26 of the system operator includes at least two databases for storing and maintaining information regarding employers 28 and employees 30 and transaction data statistics and related programs.

### System Operation

The method of the embodiment to be described in conjunction with the system described, comprises multiple macro events that are performed to achieve the results that solve the problems in the existing art relating to matching employers and job candidates in an efficient and expeditious manner, including preparing the employer information and formatting that information for a particularized method of distribution, distributing the information, permitting the job candidates to access the information under certain conditions including the provision of personal information, storing and maintaining the employer and prospective employee information in a database for selective access.

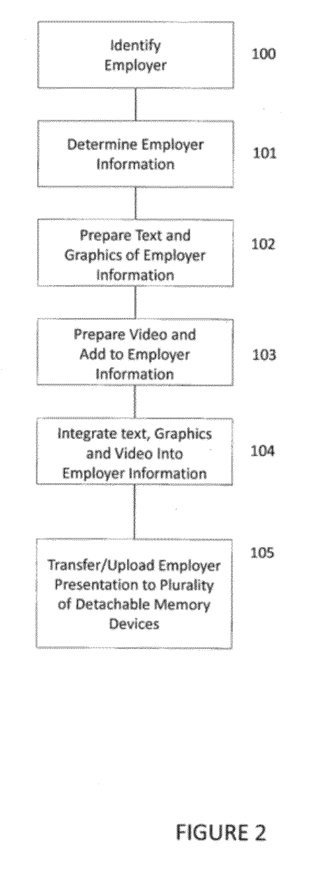

Referring to FIG. 2, the system operator identifies a prospective employer as shown at 100 who may be advantaged by use of the method and system. The employer who commits to the system and the system operator collaborate in the determination at 101 of employer information as described above. In particular, the system operator after planning with the employer as to the presentation of the characteristics of the employer's activities defines a format of textual and graphic information at 102 that portrays the image that the employer desires to communicate to job seekers. This information includes a video presentation that is prepared and edited at 103 in a typical manner known to those of ordinary skill in the art. The video length and subject matter will be determined by the employer and the presentation prepared, directly or indirectly, by the system operator. The text, graphics, and video are integrated into a complete presentation at 104.

The employer presentation is transferred or uploaded to a suitable storage medium that may be used as a master to replicate a plurality of copies. The master is then transferred or uploaded to a plurality of detachable memory devices at 105. The devices contain information relating solely to the employer that is permanently stored in the memory of the device and may include additional storage space that may be used by the recipient, job seeker, of the device.

The system operator identifies third party intermediaries that may be distributors of the detachable memory devices at 201. These entities are affiliated with a cohort of job seekers in various ways. For example, at an educational institution, there is likely a placement office and an administrator of that function on behalf of students, that is, the cohort of job candidates. At a job fair, the entity may comprise an exhibitor that will represent the system operator and will be affiliated or in contact with a candidate cohort, that is, the attendees at the fair. In certain instances the system operator may act as the intermediary or distributor by creating an affiliation through the possession of a list that may be available from an organization, or society, or licensed professionals that provides physical mailing addresses. For example, lists are available from state or national licensing agencies within specific fields such as, physicians, nursing, attorneys, etc. Other lists are available from societies or organizations such as The American Physical Therapy Association

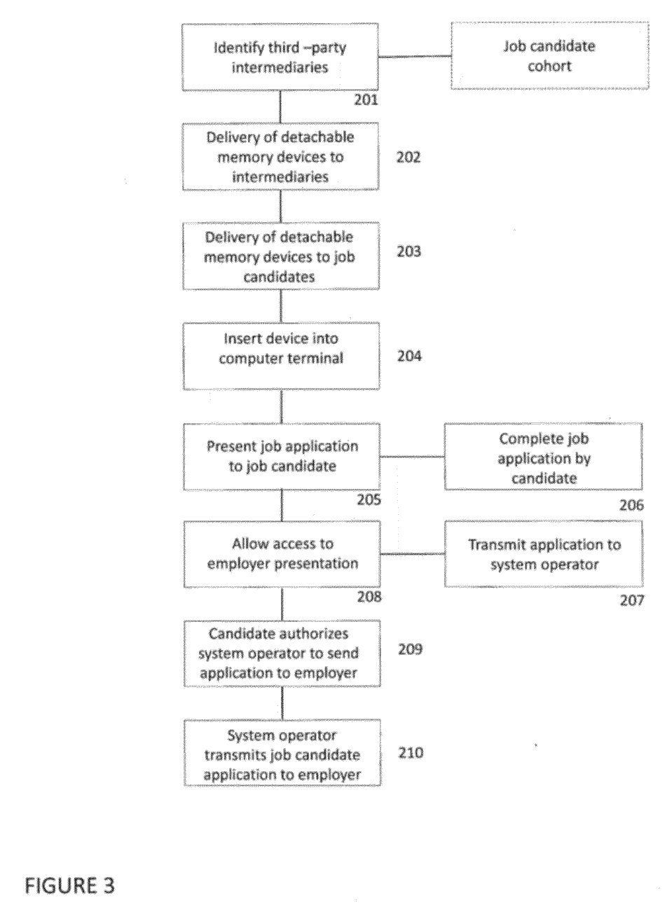

Referring now to FIG. 3, the system operator than physically distributes the detachable memory devices with the employer information to the entity that functions as the distributor having an affiliation with a job candidate cohort at 201. The devices are accompanied by a suitable label, card, package or other hard copy advertising or marketing material that identifies the employer. The distributor physically delivers the detachable storage devices to potential job applicants that are interested in the employer. The intermediary may include a mailing service through which the devices may be distributed.

The job seeker, once in possession of the detachable device may insert the device into a computer terminal to access the employer detailed information at 204. The microcontroller program on the device presents at 205 a short, preferably, but not necessarily, standardized job application or form that may be readily filled out and when completed at 206 may be transmitted to the system operator at 207. When the job application is received at the system operator server, it automatically transmits a message to the sending terminal that allows the user to access the employer presentation at 208. The job seeker may, if interested in the opportunity, send a message to the system operator, instructing the operator at 209 to release the application form to the employer for further exploration and negotiation of available opportunities at the employer. The system operator forwards the application to the employer at 210 for follow-up with the prospective candidate.

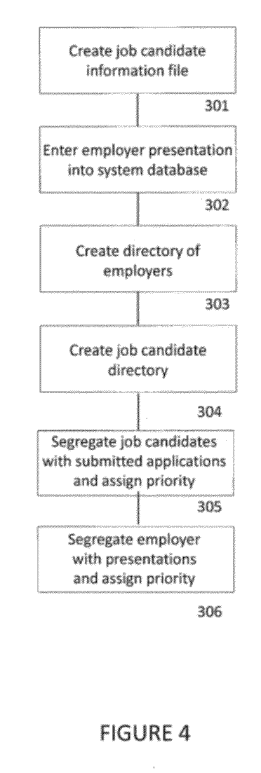

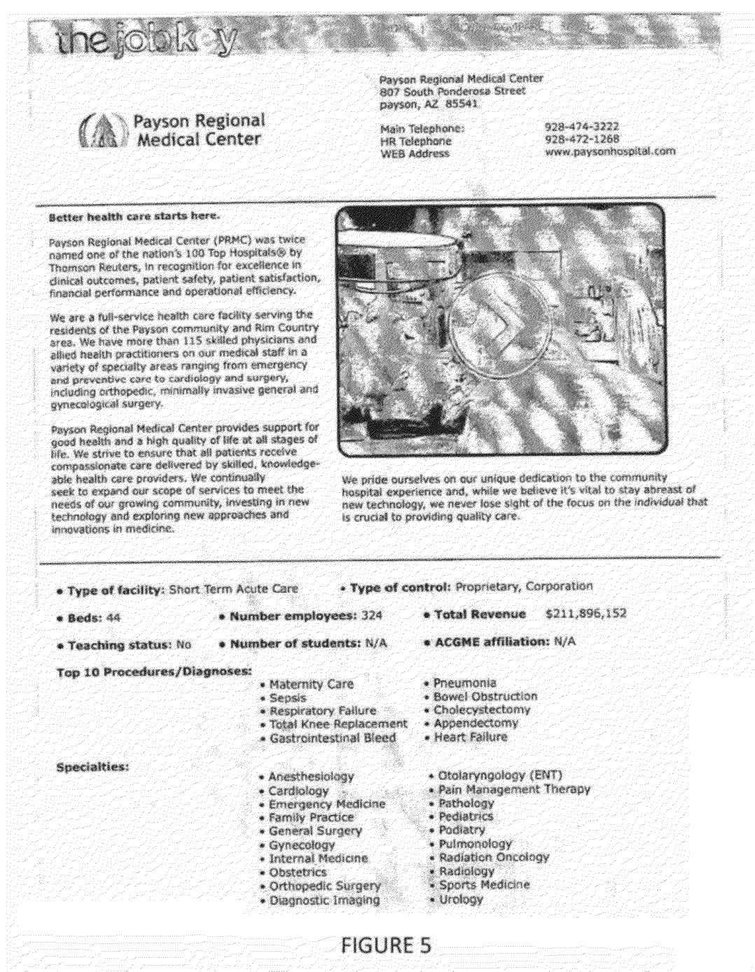

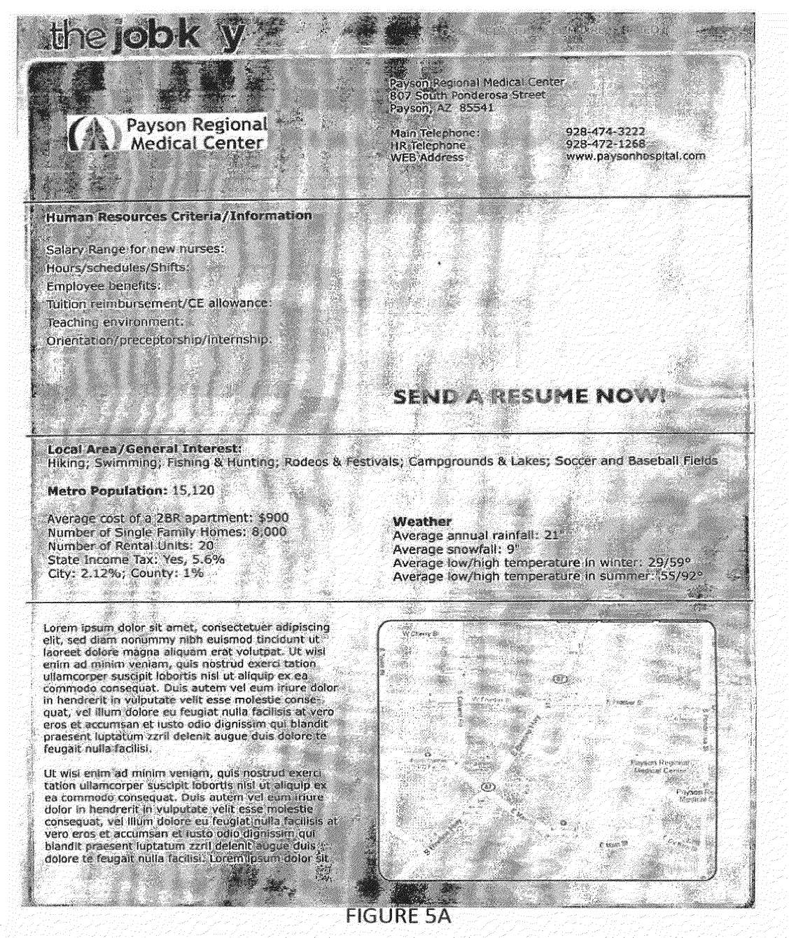

Turning to FIG. 4, the system operator upon receipt of the job seeker's application, at 301, creates a job candidate file including the event by date, candidate and assigned code number, employer presentation, location of employer, type of employer business, type of position and other information relating to the job candidate. The employer presentation, if not earlier entered into the server, is entered at 302. An employer and job candidate database is created at 303 and 304 to permit either to conduct searches of the other. It may be built through a variety of sources in a manner well known in the art. However, the system search function provides priority in time and preference in search results (“hits”) to employers who have created a presentation at 305 and to job candidates who have provided completed applications at 306. In other words, the candidates and employers that have cooperated earlier in providing information are provided with a continuous advantage in the above-described embodiment of the invention.

An example of a presentation that the embodiment of the invention may create and distribute for an imaginary medical center is shown in FIGS. 6 and 6A.

The exemplary procedure or method described above may be deployed in a variety of ways including a sequence of steps that may vary from that described. Moreover, additional steps may be included to tailor the system and method to various industries, types of job candidates, geographic areas, and the like. It is also possible to use some of the steps and not others or to include candidates cohorts formed in a manner other than that described. There are also various entities that may function as intermediaries or third parties that have affiliations with job candidates that are not described here but may be inferred from the described function performed. Accordingly, it is intended that the invention be limited only by the claims attached and not narrowed in scope by statements in this specification that were intended to describe embodiments in which the invention may be implemented, rather than as constraints or restrictions formed by a crabbed interpretation based on these examples.

I claim:

1. A method for facilitating the employment process comprising:
identifying a potential employer;
preparing descriptive material regarding the potential employer, including a video presentation of the employer's facility and personnel;
preparing a plurality of detachable memory devices, each device to include:
a blank application for employment;
an interface to a communication terminal;
the descriptive material of the employer;
an operational procedure stored on the device that prohibits access to the descriptive material without completing and transmitting the application;
identifying an administrative entity associated with a cohort of job candidates;
sending a plurality of the detachable memory devices to the administrative entity for distribution to the cohort;
permitting the job candidates to access the communication procedure on the devices to transmit the application for employment;
receiving the filled out standardized application at a central server;
storing said filled out standardized application at a central server;
maintaining a database of said stored applications.

2. The method of claim 1 additionally including receiving the employer descriptive material in the central server operated by the system.

3. The method of claim 1 additionally including limiting access to the employer descriptive material database to job candidates that have completed and transmitted the application.

4. The method of claim 3 additionally including providing access to the job candidates that have filled out applications for the employer after a period of time measured from the entry of the application in the database.

5. The method of claim 1 wherein the detachable memory device includes free memory that is useable by the recipient of the device after filling out the application to store other information.

6. A method for facilitating the employment process comprising:
preparing a video presentation of the salient features of an employer's business;
loading the visual presentation onto a plurality of USB-compatible memory devices together with:
a form that a job candidate can electronically fill out,
a computer program including software for permitting the upload of the form onto a computer terminal, the terminal connected to a network;
delivering the memory devices to a distributor-exhibitor at job fairs and like events for distribution to job candidates;
permitting access to the visual information on the memory devices by a job candidate via a computer terminal only in the event the job candidate has completed filling out the form;
downloading the form onto a computer server connected to the interne;
storing the form information in a database in a server; and
providing selective online access to the employer to the database of job candidates that filled out the form.

7. The method of claim 6 wherein the job candidates are students enrolled in a post-secondary school.

8. The method of claim 7 wherein the job candidates are nearing completion of a formal education program.

9. The method of claim 8 wherein the job candidates are receiving formal training within their field.

10. The method of claim 6 wherein memory device employer information includes information selected from the group comprising: geographic location, size, opportunities currently available, and other employer information.

11. The method of claim 10 wherein the memory device includes unused data storage.

12. The method of claim 6 wherein the distributor-exhibitor is affiliated with the post-secondary school.

13. The method of claim 6 wherein the job candidate information in the database may be selectively updated only by the job candidate.

14. The method of claim 6 additionally including an employer database including the video presentation.

15. The method of claim 14 wherein the employer database may be accessed by a job candidate who has filled out the form.

16. The method of claim 15 wherein the operator of the server has the video presentation for an employer prepared by arrangement with the employer.

17. A system for facilitating the employment hiring process, comprising:
a computer server for communicating with the internet;
a video production device for capturing a video of selected aspects of an employer's activities;
a plurality of detachable memory devices for storing the employer video, said devices additionally including a blank job candidate application form for completion by a job applicant, an interface to a computer terminal, and a computer program for selectively prohibiting access to said employer video prior to completing and transmitting said application form from said computer terminal to said server;
distribution means for physically delivering said devices to job candidates from a central source; and
said server including a database for storing said completed job candidate completed application forms.

18. The system of claim 17 wherein said devices include unused storage space.

19. The system of claim 18 said devices are USB-compatible devices.

20. The system of claim 17 wherein said server includes an employer database.
